(19) United States
(12) Patent Application Publication
(10) Pub. No.: US 2016/0019511 A1
(43) Pub. Date: Jan. 21, 2016

(54) METHOD AND SYSTEM FOR PROVIDING TIERED CONTENT

(71) Applicant: SME CONSOLIDATED LTD., Newark, NJ (US)

(72) Inventors: ELLIOT BETESH, Brooklyn, NY (US); MARGUERITE BETESH, Brooklyn, NY (US)

(21) Appl. No.: 14/800,471

(22) Filed: Jul. 15, 2015

Related U.S. Application Data
(60) Provisional application No. 62/025,335, filed on Jul. 16, 2014.

(51) Int. Cl. G06Q 20/12; G06Q 30/06

(52) U.S. Cl. CPC G06Q 20/123; G06Q 30/0641

(57) ABSTRACT

The present disclosure includes methods for providing content. In one embodiment, a method includes providing by a processing element a primary content slot for purchase and a secondary content slot for purchase, receiving by the processing element a user selection of the primary content slot, receiving by the processing element a user selection of the secondary content slot, enabling by the processing element a primary communication pathway to a primary user device and a host device, and enabling by the processing element a secondary communication pathway to a secondary user device.

### CROSS REFERENCE TO RELATED APPLICATIONS

This application claim the benefit of priority to U.S. Provisional Application No. 62/025,335 filed 16 Jul. 2014 and entitled “Method and System for Providing Tiered Content,” which is hereby incorporated by reference herein in its entirety.

### FIELD

The present invention relates generally to methods for providing content, and more specifically, to methods for selectively providing tiered content to user devices.

### BACKGROUND

Online websites and applications allow viewers to connect with celebrity content, such as YOU TUBE, where users may view previously recorded videos of celebrities, such as music videos, interviews, and so on. However, this type of celebrity content is viewable by a user only after it has been recorded, i.e., not in real time. Additionally, the celebrity content does not typically allow a user to interact with the celebrity. Certain celebrities may wish to have more interactive experiences with their fans. The present disclosure provides a method and system for allowing celebrities to interact with and provide content to their fans.

### SUMMARY

Examples of the disclosure may include a method for providing content. The method includes providing by a processing element a primary content slot for purchase and a secondary content slot for purchase, receiving by the processing element a user selection of the primary content slot, receiving by the processing element a user selection of the secondary content slot, enabling by the processing element a primary communication pathway to a primary user device and a host device, and enabling by the processing element a secondary communication pathway to a secondary user device.

Another example of the present disclosure may include a method for distributing content. The method includes transmitting by a processing element to a user device a menu of content selections, receiving by the processing element a user selection corresponding to one or more content selections, determining a ranking of the user selection based on a predetermined metric, and when the user selection has a high ranking, activating a primary connection to the user device corresponding to the content selection, and when the user selection has a low rank transmitting a rank notification to the user device.

### BRIEF DESCRIPTION OF THE DRAWINGS

FIG. 1 is a diagram of a system for providing tiered content to one or more user devices.

FIG. 1A is a diagram of a more specific example of the system of FIG. 1, including a plurality of secondary user devices, an upper tier primary user device, a lower tier primary user device, one or more talent or host devices, and a server or host device in communication with one another.

FIG. 2 is a simplified block diagram of one or more computing devices, such as a host device, user device, and/or talent device, that may be used with the system of FIG. 1.

FIG. 3A is a first example of a purchasing graphical user interface that may be used with the system of FIG. 1.

FIG. 3B is a second example of a purchasing graphical user interface that may be used with the system of FIG. 1.

FIG. 3C is a third example of a purchasing graphical user interface that may be used with the system of FIG. 1.

FIG. 3D is a fourth example of a purchasing graphical user interface that may be used with the system of FIG. 1.

FIG. 4 is an example of a primary user graphical user interface that may be used with the system of FIG. 1.

FIG. 5A is a first example of a secondary user graphical user interface that may be used with the system of FIG. 1.

FIG. 5B is a second example of a secondary user graphical user interface that may be used with the system of FIG. 1.

FIG. 6 is a flow chart illustrating a method for selling and receiving purchases of content slots that may be used with the system of FIG. 1.

FIG. 7 is a flow chart illustrating a first example of a method that may be used to transmit and receive tiered content to various user devices.

FIG. 8 is a flow chart illustrating a second example of a method that may be used to transmit and receive tiered content to various user devices.

### SPECIFICATION

The present disclosure relates generally to methods and systems for selectively providing content to a plurality of user devices to allow users (e.g., audience members) to view the content. The content may be tiered so that the interactions of the user devices with the content may be varied based on the type of interaction selected by the user. For example, a first type or primary content may be wholly interactive between the user device and the host device and a second type or secondary content may be passive or otherwise have a limited functionality. In particular, based on a user selection, the content may be active (i.e., allow the user to participate in some manner) or may be passive (i.e., prevent the user from participating in the content other than passively watching or listening).

As used herein, the term content is meant to describe audio, visual, and/or text related content, such as, but not limited to, videoconferencing, streaming visual or audio content, and/or chat applications. The content may be two-way which includes transmitting and receiving content between a host device/talent device and a user device, the content may be on-going, dynamically generated, or otherwise “live.” The content may be transmitted continuously during a select time period, where the primary user may interact with the content during transmission and the secondary user may view and/or listen to the content during transmission, but with limited functionality as compared to the primary user. It should be noted that although the content has been described as being “live” or substantially live, this term is meant to encompass instantaneously transmitted content, as well as content with a time delay, or the like. The primary user devices are enabled to allow the primary users to engage with and add to the content, whereas the secondary users can receive the content (both from the host and primary devices) while the communication pathway between the primary user and the host is enabled (i.e., prior to termination of the communication pathway), so that the secondary user may in view the content as it is occurring. For example, a time delay that is less than the duration of the time slot may still be considered to be “live” or substantially live in some embodiments, other delays may include a few seconds, a few minutes, and so on. In many embodiments, the secondary transmission may be delayed with respect to, but begin prior to, the primary transmission being completed, and in other embodiments, the primary and secondary transmissions of the content occur at substantially the same time.

In one embodiment, the system includes offering a menu of content selections to a user, such as blocks of time corresponding to the content, where the user can pay a first price for primary content and a second price for secondary content. By offering varying access levels to the content, a content provider may be able to receive multiple payments for a single content offering, while the users may be able to save money by purchasing a more restrictive content offering. As another example, the first level of content may be available for purchase, whereas the secondary levels of content may be available for free but may include commercial content displays (e.g., advertisements, sale offerings, and so on).

In a specific example, the content provider may provide blocks of time for purchase, such as by auction or other sale, although other forms of allocating blocks may be employed in alternative embodiments (e.g., gifting, transferring, raffling, and so on). The blocks of time can be for viewing and/or interacting with the content where the interactive content includes a videoconference or chat with a “personality” or talent, such as, but not limited to, celebrity, athlete, professor, professional or other person people desire to interact with. The auction allows users to bid on blocks of time and where the top-bidding user may have the first selection on the time block or may win the active content and the remaining bidders may have to rebid for spots to view and/or listen to the active content. Alternatively or additionally the time slots may be purchased through a direct purchase where the owner and/or Talent may set the prices. For example, certain time slots may be set as auction items whereas other time slots may be select as direct purchase slots, or vice versa.

The user devices that purchase active content are enabled to provide one or more two-way or interactive functions, such as, but not limited to, audio, voice, or text, or combinations thereof. This allows dynamic adjustment of the functionality availability to a particular user based on the results of the auction or purchase by the user. The system may also include alternative revenue streams, such as commercial content windows (e.g., advertisements, sales links, sale displays) or the like. In some embodiments, commercial content is transmitted so as to be displayed on the user devices and may be selected from a range of substantially any type of commercial products, services, etc., but often may be configured to related to the talent or celebrity, the topic of conversation, the location of the user and/or talent, or the like. As one example, the commercial content may include a link to purchase a jersey or other memorabilia related to the Talent. Additionally, the commercial content displayed may be varied dynamically, allowing the content to be tailored to a specific user, Talent, time, date, location, conversation topic, and so on.

As a specific example, a method of the present disclosure may be used to create an application for one or more mobile device platforms (e.g., smart phones, gaming devices, tablet computers, set top boxes, or other computing devices) where users can purchase time slots to interact with a celebrity. A first set of slots allow a user to directly engage with the celebrity, such as participate in a videoconference or video chat with the celebrity where the user can pose questions to the celebrity, have a conversation with the celebrity, and/or transmit pictures, videos, or audio recordings to the celebrity, or otherwise have a two-way interaction with the celebrity. A second set of slots may allow one or more users to have a passive interaction with the celebrity where the second set of users may watch and/or listen to the interaction between the celebrity and the first user. For example, the secondary user may view a stream of the videoconference between the celebrity and the first user but may not be able to audibly participate in the conference. However, in some embodiments, the secondary user may have a limited communication mechanism, such as a text or chat function, which allows the secondary user a lower level of interaction with the celebrity. The first set of slots may be sold at a higher price than the second set, which allows a user to interact with a celebrity based on a desired price that he or she wishes to spend.

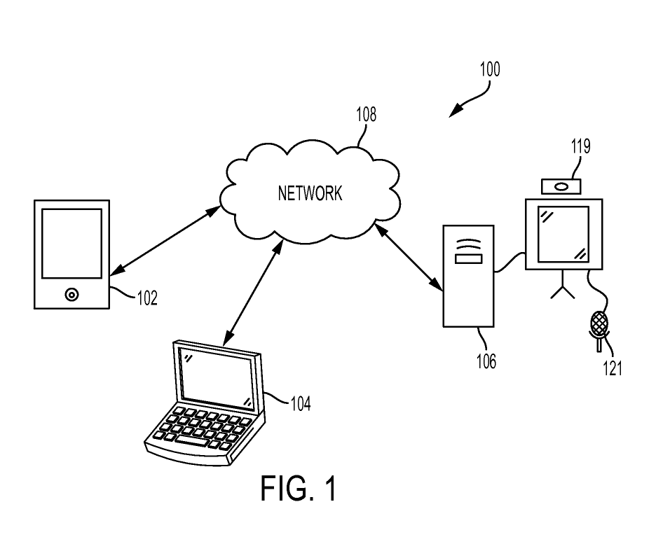

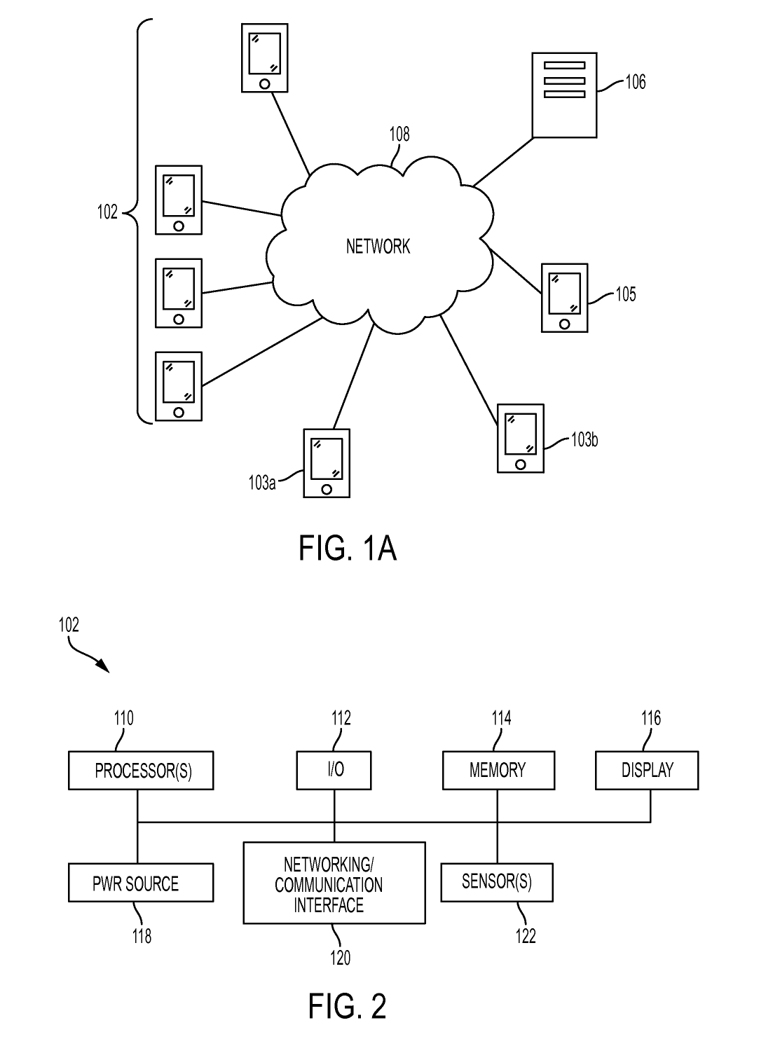

Turning to the figures, a system for selectively providing tiered content will now be discussed. FIG. 1 is a system 100 for providing content including a plurality of computing devices 102, 104, 106 in communication with one another via a network 108. FIG. 1A is an example of the system of FIG. 1 illustrating a plurality of user and host devices. FIG. 2 is a simplified block diagram of a computing device that may be used with the system of FIG. 1. With reference to FIGS. 1-2, the computing devices 102, 104, 106 may be substantially any type of computing device, such as, but not limited to, smart phones, tablet computers, desktop computers, laptop computers, servers, portable gaming devices, set top boxes, televisions, portable media players (e.g., Blu-Ray, DVD, etc.), wearable devices, portable music players, and so on. The computing devices 102, 104, 106 may include one or more user or client devices and one or more hosting or server devices. For example, the third computing device 106 may be a server or other hosting device and may transmit and receive data to and from the user devices 102, 104.

The number of client or user devices 102, 104 and hosting devices 106 may be varied. For example, in some embodiments, there may be multiple client devices 102, 104 with a plurality of hosting devices 106 or a single hosting device 106. The number of hosting devices 106 may depend on the resolution of the content, the type of the content, the amount of content, and the number of user devices trying to access the content, as well as other factors. It should be noted that the discussion of the computing devices herein is applicable to both the user devices and the hosting devices, with the components of each being varied based on the desired use and demands. Additionally, although FIG. 2 is discussed with respect to the computing device 102, the other computing devices 104, 106 may include substantially the same components and as such the discussion of the computing device 102 is applicable to the other devices 104, 106.

With reference to FIG. 1A, in some embodiments the system 100 of FIG. 1 may include a server 106 that may host a website or other access to the one or more graphical user interfaces and communication pathways discussed below, a talent device 105, an upper tier primary user device 103a, a lower tier primary user device 103b, and a plurality of secondary user devices 102. With reference to FIG. 1A, in this example, the server 106 may provide communication between the user devices 102, the primary user devices 103a, 103b, and the talent device 105 to allow the user devices to communicate with the talent device 105 as described in more detail below. For example, data, such as video, voice, and text may be transmitted between the talent device and the various user devices, but the server 106, talent device 105, or other host device may selectively enable the types of data that may be transmitted and/or received between each device based on the user access level, also discussed in more detail below.

With reference to FIG. 2, the computing device 102 may include one or more processing elements 110, an input/output interface 112, one or more memory components 114, a display 116, a power source 118, a networking/communication interface 120, and/or one or more sensors 122 in communication with each other via one or more systems busses or via wireless transmission means, each of the components will be discussed in turn below.

The one or more processing elements 110 may be substantially any electronic device capable of processing, receiving, and/or transmitting instructions. For example, the processing element 110 may be a microprocessor or a microcomputer. Additionally, it should be noted that the processing element 110 may include more than one processing member. For example, a first processing element may control a first set of components of the computing device 102 and a second processing element may control a second set of components of the computing device 102, where the first and second processing elements may or may not be in communication with each other, e.g., a graphics processor and a central processing unit which may be used to execute instructions in parallel and/or sequentially.

The input/output interface 112 allows the computing device 102 to receive inputs from a user and provide output to the user. For example, the input/output interface 112 may include a capacitive touch screen, keyboard, mouse, camera, stylus, or the like. The type of devices that interact via the input/output interface 112 may be varied as desired. Additionally, the input/output interface may be varied based on the type of computing device used. For example, with reference to FIG. 1, the computing device 106 may include a video camera 119 and a microphone 121 that allow a user and/or Talent to provide input to the computing device. Other computing devices may include similar sensors and other input/output devices.

The memory 114 stores electronic data that may be utilized by the computing device 102. For example, the memory 114 may store electrical data or content e.g., audio files, video files, document files, and so on, corresponding to various applications. The memory 114 may be, for example, non-volatile storage, a magnetic storage medium, optical storage medium, magneto-optical storage medium, read only memory, random access memory, erasable programmable memory, flash memory, or a combination of one or more types of memory components.

The display 116 may be separate from or integrated with the computing device 102. For example, in instances where the computing device 116 is a smart phone or tablet computer the display 116 may be integrated with the computing device 102 and in instances where the computing device is a server or a desktop computer the display 116 may be separate from the computing device 102. The display 116 provides a visual output for the computing device 102 and may output one or more graphical user interfaces (GUIs). The display 116 may be a liquid display screen, plasma screen, light emitting diode screen, and so on. The display 116 may also function as an input device in addition to displaying output from the computing device 102. For example, the display 116 may include capacitive touch sensors, infrared touch sensors, or the like that may capture a user's input to the display 116.

The power source 118 provides power to the various components of the computing device 102. The power source 118 may include one or more rechargeable, disposable, or hardwire sources, e.g., batteries, power cord, or the like. Additionally, the power source 118 may include one or more types of connectors or components that provide different types of power to the computing device 102. The types and numbers of power sources 118 may be varied based on the type of computing devices.

The networking/communication interface 120 receives and transmits data to and from the computing device 102. The networking/communication interface 120 may transmit and send data to the network 108, other computing devices, or the like. For example, the networking/communication interface 120 may transmit data to and from other computing devices through the network 108 which may be a wireless network (Wi-Fi, Bluetooth, cellular network, etc.) or a wired network (Ethernet), or a combination thereof. In particular, the network 108 may be substantially any type of communication pathway between two or more computing devices. For example, the network 108 may be wireless, wired, or a combination thereof. Some examples of the network 108 include cellular data, Wi-Fi, Ethernet, Internet, Bluetooth, closed-loop network, and so on. The type of network 108 may include combinations of networking types and may be varied as desired.

The sensors 122 may provide substantially any type of input to the computing device 102. For example, the sensors 122 may be one or more accelerometers, microphones, global positioning sensors, gyroscopes, light sensors, image sensors (such as cameras), force sensors, and so on. The type, number, and location of the sensors 122 may be varied as desired and may depend on the desired functions of the system 100. In many embodiments, the computing device 102 may at least include a camera sensor and a microphone or other sound sensor.

As will be discussed below, the computing device 102 and the network 108 may be used to perform one or more operations of the method to allow the purchase and transmission of tiered content.

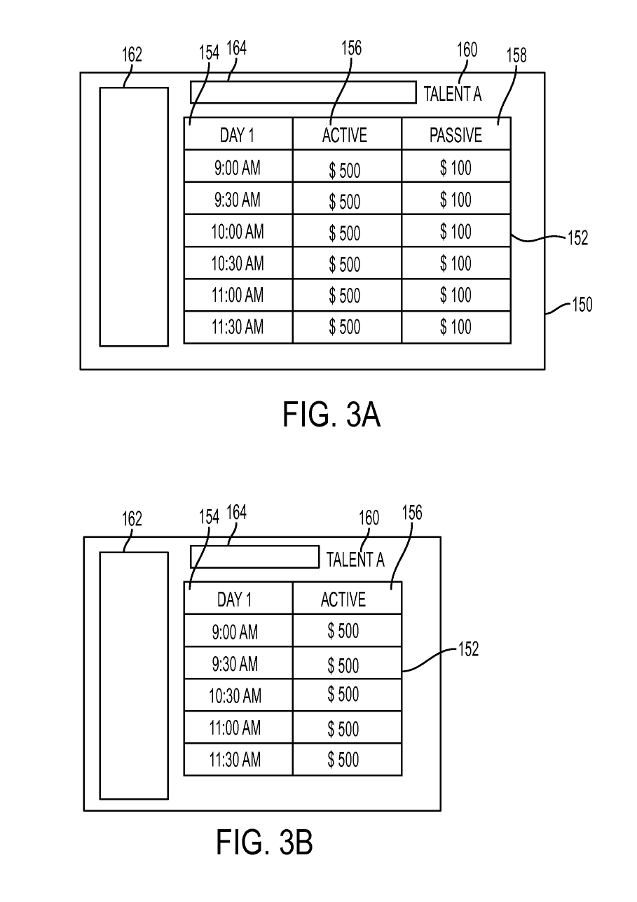

Examples of GUIs that may be used to purchase, transmit, and/or receive tiered content in accordance with the system 100 of FIG. 1 will now be discussed. FIGS. 3A-3D illustrate various examples of a purchasing GUI. With reference to FIG. 3A, in a first example, a purchasing GUI 150 may be displayed on the display 116 of a user's computing device 102. The purchasing GUI 150 may include a content menu 152 including a plurality of options for purchase, such as, but not limited, to a Talent section 160 (e.g., Talent A), a date selection 164, a primary selection 156, and a secondary selection 158. Additionally, the purchasing GUI 150 may include one or more commercial content windows 162, 164 positioned around the menu 152 or located within the menu 152.

As shown in FIG. 3A, in this example, the content menu 152 may include price display for a date and time for an interaction with a particular person, in this case Talent A. The prices may vary based on type, e.g., primary 152 or secondary 158, and may also vary based on the time or day. For example, the price for a Friday at 4 pm may be higher than the price for a Monday at 9 am. Additionally, the pricing may be varied based on the demand for the specific talent, the number of available slots, the time, date, and so on.

Using the content menu 152, the user may select a particular content type, primary or secondary, as well as a desired time and date. Based on the selection, the user may be required to pay a fee or other consideration (as will be discussed in more detail below), to be provided with access to the specified content. For example, if the user selects the primary content for Talent A on Day 1 at 9:00 am, he or she may be provided with an active communication pathway to the Talent A, such as a videoconference or telephone conference, at the specified date and time. It should be noted that although dates and times are listed, in some embodiments the content menu may be limited to substantially instantaneous content, i.e., as soon as a user purchases a content slot he or she is connected to the selected content.

With reference to FIG. 3B, in some embodiments, the content menu 152 may only include purchasing options for primary content slots 156. In this example, the purchasing GUI may not include options for secondary users as those users may be able to view the content for free, for example while being shown a commercial content display. As such, in the example in FIG. 3B, the GUI may include just purchasing slots for the active content.

As shown in FIGS. 3A and 3B, in some embodiments, the content menu 152 may display the prices for select content. However, with reference to FIG. 3C, in some embodiments, the content menu 152 may display the current status for each content slot, e.g., available or purchased. The user may then select an available content slot to place a bid for the slot, view the price, or other notification regarding how to receive the content (e.g., watch an advertisement video, complete a survey, donate items, transfer money or items, etc.). In other examples, certain levels of content may be available for free and/or may require a user to view a commercial content display, such as an advertisement or sale offering link, in order to view the talent content.

As shown in FIGS. 3A and 3C, the purchasing GUI 150 may include one or more commercial content windows 162, 164 and/or banners positioned throughout the GUI 150. The commercial content windows 162, 164 may vary based on the desired type of ads that are to be displayed and/or other factors such as, but not limited to, user access level, membership, type of talent, and so on. As an example, a “VIP member” may pay a yearly or monthly subscription fee and may not have any commercial content windows (e.g., commercial content banners or product sales windows) on his or her GUI, whereas other users may have the commercial content windows. FIG. 3D illustrates another example of a purchasing GUI 150, but with commercial content windows in different locations. For example, as shown in FIGS. 3A, 3B, and 3C, the commercial content windows 162, 164 may be positioned along a length and width of the purchasing GUI 150, whereas in FIG. 3D, the commercial content windows 167 may be positioned in each of the corners of the purchasing GUI 150. However, it should be noted that many other locations may be used and the above examples are meant as illustrative only. For example, the GUI may include one or more pop up commercial content windows that may temporarily hide the content menu 152 and/or commercial content windows that are positioned within the content menu 152 (e.g., along a row, column, or cell within the menu).

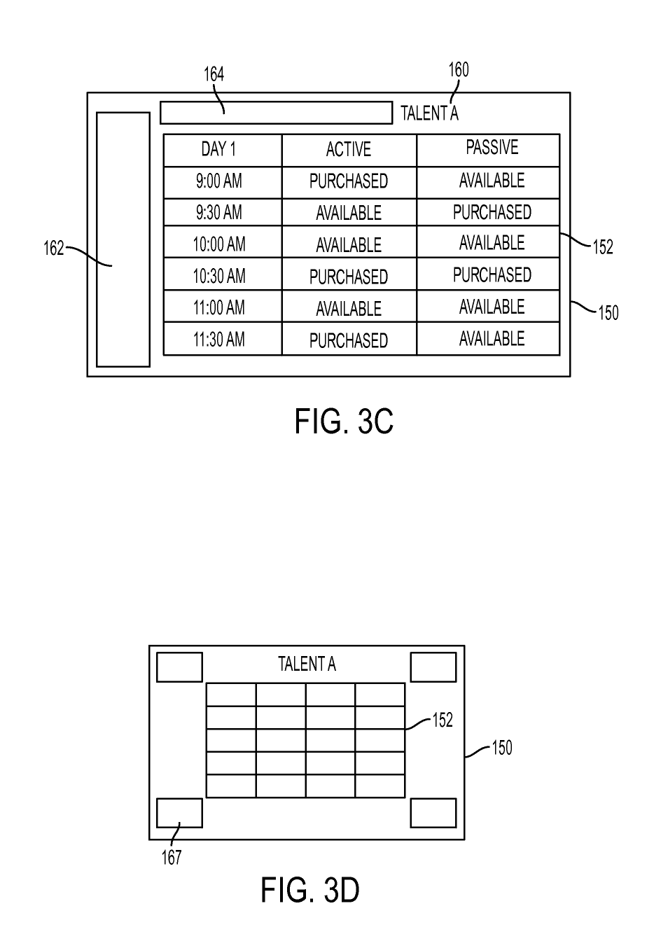

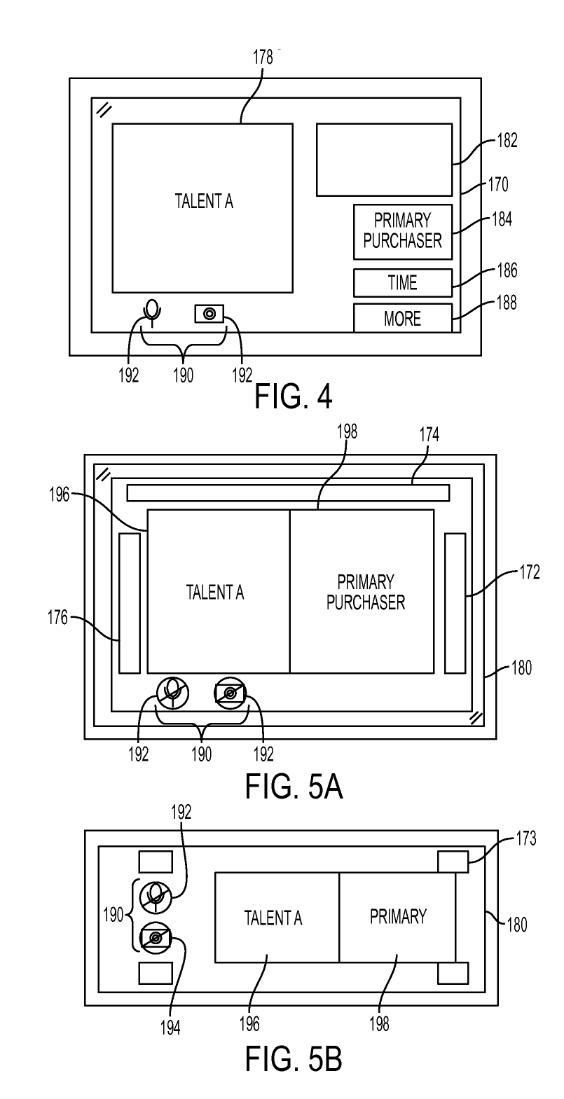

In addition to the purchasing GUI 150, the system 100 may also include a content GUI that is used to selectively display content on a user device. FIG. 4 is an example of a primary content GUI that may be used to provide content to a primary user. FIGS. 5A and 5B illustrate examples of a secondary GUI that may be used to provide content to a secondary user. With reference initially to FIG. 4, the primary GUI 170 may include a talent window 178, a user window 184, one or more functionality icons 190, commercial content windows 182, and optionally one or more status icons 186, 188. The talent window 178 displays the purchased content on the display 116 and/or indicates that audible output is currently occurring (e.g., output through one or more speakers connected to the computing device). For example, in instances where the content is a videoconference between a user and Talent A, the talent window 178 provides a video of the Talent A person during the videoconference. Similarly, the user window 184 provides feedback to the user, such as a video of the user as it is displayed to the Talent A person. In this example, the talent window 178 may be larger and optionally have a higher resolution than the user window 184. However, in other embodiments the user window 184 may be varied or omitted.

With continued reference to FIG. 4, the functionality icons 190 may include a sound icon 192 and/or a video icon 194. The functionality icons 190 indicate the enabled functions for the content. With the primary GUI 170, both the sound and the video inputs may be enabled of the user, so as shown in FIG. 4, the sound icon 192 and the video icon 194 are indicated as being active. However, depending on the type of content purchased and/or the settings for the content, the type of functions may be varied, e.g., certain primary content selections may include audio only, with secondary users all input functions sound and video may not be activated, etc.

The status windows 186, 188 may be used to provide status or other information to the user through the primary GUI 170. For example, a first status window 186 may include the time remaining on the purchased time slot. In this example, the user may be able to view the time remaining on his or her purchased slot. Additionally, the second status window 188 may allow a user to navigate to other GUIs within the program, such as, but not limited to, purchasing additional time and returning back to a main menu.

In addition to the content windows and icons, the primary GUI 170 may also include one or more commercial content windows 182. The commercial content windows 182 may be used to display advertisements, offer links to websites that sell products, provide commercial products, services, or the like. In other words, the commercial content windows may be used to display advertisements for commercial products or services, as well as offer for sale or provide direct links to those commercial products. The commercial content windows may be sold or may be incorporated into the revenue stream of the system (e.g., related companies, websites, and/or products may be sold or displayed through the commercial content windows). Although the commercial content window 182 is shown as being located adjacent to the talent window 178, in other embodiments the commercial content window 182 may be located substantially anywhere on the primary GUI 170, such as in one or more of the corners, along the edges, or the like. Additionally, the primary GUI 170 may include two or more commercial content windows, where each window may be location a different location from the other.

With reference now to FIGS. 5A and 5B, the secondary GUI 180 may be used to display content to a secondary user, e.g., a user with only output functionality. In this example, the secondary GUI 180 may be somewhat similar to the primary GUI 170, but may include a primary window 198 adjacent a talent window 196. In this example, the talent window 196 may be substantially similar to the talent window 178 of FIG. 4. The primary window 198 may be similar to the talent window 196 in that it may be used to display an output, such as a video, but rather than the Talent A, the primary window 198 may be used to display a video of the primary user interacting with the Talent A (e.g., through a videoconference). Because the secondary GUI 180 may display both the Talent A and the primary user, the windows 196, 198 may be substantially the same size, or alternatively may be differently sized. Additionally, as the secondary user is typically passive, the secondary GUI will have interactive or input restrictions with the content being viewed so that the secondary user may be able to view and/or hear the content between both the primary user and the Talent A but may not be able to participate.

For example, the secondary GUI 180 may include the functionality icons 190, but in this example, both the microphone icon 192 and the camera icon 194 are crossed out, differently colored, deemphasized, or otherwise varied to alert the secondary user that he or she does not have these functions (e.g., the sound and video from the user device is not being transmitted or included with the content). The secondary GUI 180 may also include one or more commercial content banners or windows 172, 174, 176 located at various locations along the secondary GUI 180. In one embodiment, the secondary user may pay a lower price for the content and so may include more commercial content windows than the primary GUI 170. However, in other embodiments, the number of commercial content windows may the same, or varied in other manner (e.g., users that are members may not have commercial content displays/windows whereas viewers that are not members may have commercial content displays, and so on).

With reference to FIG. 5B, as discussed above, the location, size, and shape of the commercial content windows may be varied as desired and so in FIG. 5B are shown in different locations than FIG. 5A. However, it should be noted that the examples of the commercial content windows shown in FIGS. 4-5B are meant as illustrative only and many other types and locations of commercial content windows are envisioned. Further, although certain placement of the commercial content windows has been discussed with respect to a particular GUI, it should be understood that the commercial content windows discussed with any GUI may be applied to any other GUI as desired.

It should be noted that although the above user interfaces have been discussed with respect to primary and secondary users, in some embodiments, there may be more than two content and user levels. For example, while in one embodiment there is only a single primary user, in another embodiment, there may be an upper tier primary user, a lower tier primary user, and a plurality of secondary users (which secondary users may include a single or multiple sub-tiers of content level and users), or other arrangements. In one such embodiment, the content access includes multiple tiers, in this case three tiers, so as to vary the functionality and accessibility of the content based on the user level. In this example, the upper primary users may have full functionality during the content stream for the entire time slot and the secondary users may have the one-way communication discussed above. However, the lower tier primary users may have full functionality for only a part of the time slot, may have their functionality varied by the upper tier primary user (e.g., the upper tier primary user can disable one or more functions of the lower tier primary user, such as, muting, hiding, or the like), and/or the lower tier primary user may have only partial two-way functionality (e.g., voice but no video, video but no voice, etc.). In other words, the lower tier primary user may have a subset of control and/or access as compared to the upper tier primary user, but may have a greater level of access and functionality as compared to the secondary users. In some embodiments, the upper-tier primary user may be given control over the lower-tier primary user, such as by limiting or starting and ending the lower-tier primary user's time in which they have two-way communication, allowing for example one-way communication during the remainder of the allocated time slot.

In embodiments including an upper tier primary user, the lower tier primary user slot may be sold separately from the upper tier primary slot or may be included as part of the price of the upper tier primary slot. In the later example, the lower tier primary user may be a “guest” or otherwise invited by the upper tier primary user.

Additionally, in some embodiments, users within each tier (primary and secondary), may be able to communicate in a two-way manner with one another. For example, two or more secondary users may be able to send messages between one another and optionally with the primary users.

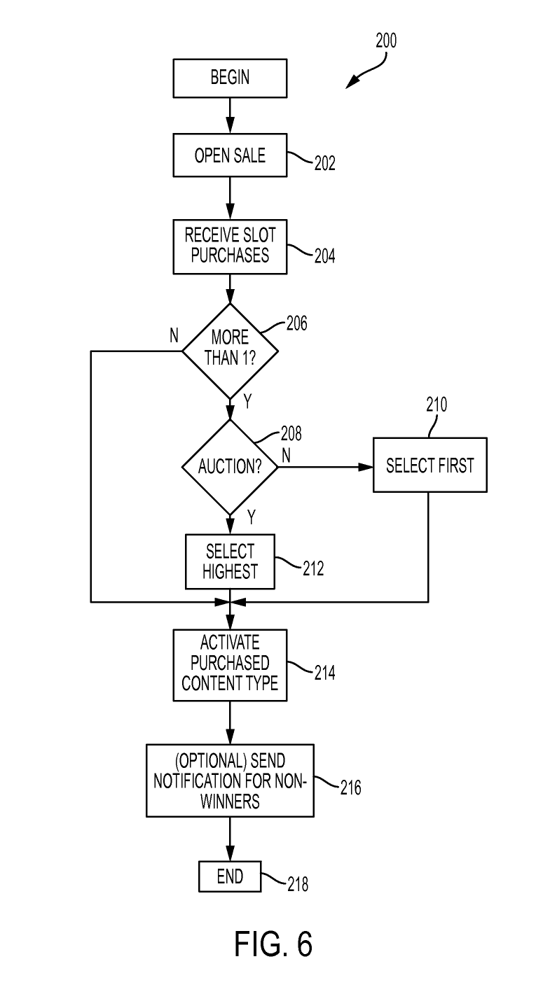

Methods for using the system 100 of FIG. 1 to provide tiered content to user devices will now be discussed in more detail. FIG. 6 is a flow chart illustrating a method for receiving purchases of content slots. With reference to FIG. 6, the method 200 may begin with the content slots being open or otherwise available for a user to select. For example, the purchase GUI 150 may be transmitted to one or more user devices to allow a user to select a particular content slot from the content menu 152. The number of content slots, the Talent for each content slot, and the cost of the time slots may be varied based on the demand, the talent, and other factors.

Once the content slots have been open for sale, the method 200 may proceed to operation 204. In operation 204, the processing element 110 of the host device 106 may receive a slot purchase from a user device. For example, the user may provide input to his or her user device (e.g., through the input/output interface 112 or display 116) to select a particular content slot on the content menu 152. When the user selection is transmitted to the host device 106, the method 200 may proceed to operation 206.

In operation 206, the processing element 110 for the host device 106 determines whether more than one user has selected the same time slot. For example, in some instances the demand for a particular content selection may be high and multiple users may wish to purchase that time slot. If there is more than one user wishing to purchase a particular content slot, the method 200 may proceed to operation 206. In operation 206, the processing element 110 determines if the particular content selection is being offered as an auction (e.g., receiving multiple bids).

If the content selection is not offered as an auction, the method 200 proceeds to operation 210. In operation 210, the processing element 110 selects the first user request for the content, e.g., first come first served. However, if the content selection is offered as an auction, the method 200 proceeds to operation 208. In operation 208, the processing element 110 selects the user that has provided the highest bid. For example, in instances where the content selections are purchased with money, the high bid may be the user bid for the most of amount of money. However, in instances where the content selections are not purchased with money, such as through charity donations, or the like, the metric used to determine the winning bid may be based on other parameters.

After operations 208, 210 or in sentences where there is not more than one user in operation 206, the method 200 may proceed to operation 214. In operation 214, the content purchased by the user, e.g., primary or secondary, is activated on the user device. For example, in instances where the content slot purchased by the user is a primary slot, the primary GUI 150 may be transmitted to the user device 102 and a two-way communication pathway between the talent computing device (which may or may not be host device 106) and the user device 102 may be activated. As another example, in instances where the content slot purchased by the user is a secondary slot, the secondary GUI 170 is transmitted to the user device 102 and a one-way communication pathway is activated between the user device and the host device 102.

After the content selection is activated on the user device, the method 200 may proceed to operation 216. In operation 216, the processing element 110 of the host device 106 may optionally transmit a notification to the other users. For example, in the auction scenario, the processing element 110 may transmit a “loss” notification, a rank notification indicating the place of the user's own bid, or otherwise inform the remaining users that they have not won the selected content.

After operation 216, or in instances where operation 216 is omitted, after operation 214, the method 200 may proceed to an end state 218. It should be noted that the method 200 is merely one embodiment that may be used to receive user selections for a particular type of content. For example, in the method 200 the users may purchase the content slots, but in other embodiments, the users may use items other than currency to purchase a select content slot. As some non-limiting examples, the content slots may be transferred to one or more users from another user or the talent, the content slots may be bartered or traded, bit coins or there non-monetary based currency elements may be used, the content slots may be won as part of a lottery or raffle, or the like. As such, the discussion of any particular method for purchasing the content slots is meant as illustrative only.

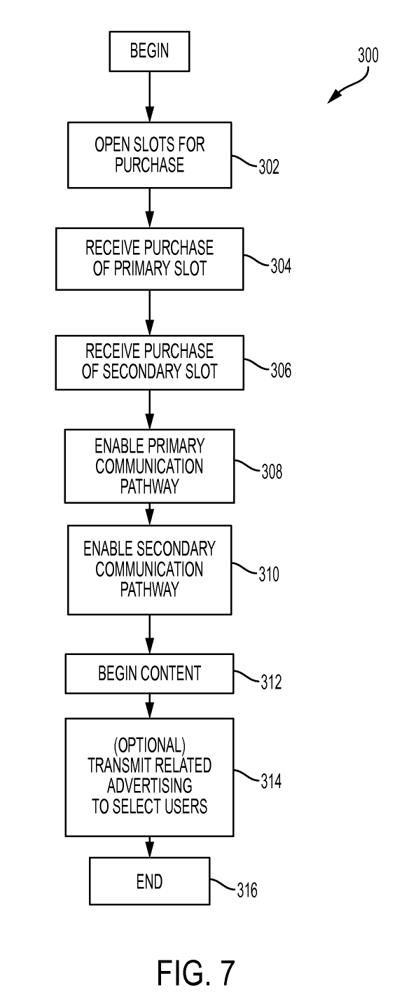

A method for enabling and transmitting the content to various user devices will now be discussed in more detail. FIG. 7 is a flow chart illustrating a method 300 for transmitting content to one or more user devices. With reference to FIG. 7, the method 300 may begin with operation 302. In operation 302, the one or more content slots may be opened or otherwise made available for purchase. This operation 302 may be substantially similar to operation 202 in FIG. 6. After operation 302, the processing element 110 may receive a purchase for a first primary content slot. For example, using the method 200 of FIG. 6, the processing element may receive a user purchase for a first primary content slot. The purchases may be direct purchases or may be part of an auction system for the content slot.

During, before, or after operation 304, the method 300 may include operation 306. In operation 306, the processing element 110 may receive a purchase for a secondary content slot. The secondary content slot may be purchased at the same time as, before, or after the primary content slot has been purchased. The second content slot may be purchased in a similar manner as the primary content slot (e.g., using the method 200 of FIG. 6), however, in many embodiments the secondary content slot may be cheaper than the primary content slot, e.g., discounted, free, or the like.

After operations 304, 306, the method 300 may proceed to operation 308. In operation 308, the processing element 110 of the host device 106 may enable a primary communication pathway. The primary communication pathway may be between the primary user device 102 and the host device 106 and optionally a talent device. For example, the host device 106 may function as an intermediary between Talent A's device and the user device to transmit and receive content between the user and the talent. As another example, the Talent device may function as the host device and may directly transmit and receive content to and from the user device. In operation 308, the primary GUI 150 may be displayed on the primary user's device to allow the user to view the talent window 178 and optionally the feedback window 184. The primary communication pathway allows the user to interact with the content and be part of the content. For example, with the primary communication pathway the user may provide input (e.g., via the camera and/or microphone sensors) that is transmitted to the Talent to allow the user to communicate directly with the Talent, such as being an active participant in a videoconferencing application.

After operation 308, or while the primary communication pathway is enabled during operation 308, the method 300 may proceed to operation 310. In operation 310, the processing element 110 may enable a secondary communication pathway between the secondary user device and the host device 106. For example, the processing element 110 of the host device 106 may transmit the secondary GUI 170 to the secondary user's user device 102 to allow the secondary user to view and/or listen to the content (e.g., the videoconference between the Talent A and the primary user), but may restrict one or more input functions, such as, audio and video input and/or text input. Thus, the secondary user, through the secondary GUI 170, may be able to passively participate in the content.

After operation 310, the method 300 may proceed to operation 312. In operation 312, the content begins. In particular the primary user is able to interact with the Talent A, such as through a videoconference, telephonic conference, and/or text exchange (e.g., chat application). The content may include input by both the Talent and the primary user. The secondary user may view and/or listen to the content while the communication pathway between the primary user and the Talent is operating, which allows the secondary user to view and/or listen to the content substantially live, after a minor time delay, or the like.

After operation 312 and while the content is being streamed to the primary and secondary users, the method 300 may proceed to operation 314. In operation 314, the processing element 110 of the host device 106 may transmit commercial content, such as, but not limited to one or more advertisements or sales windows, to the primary and second users. The commercial content may be displayed in one or more of the commercial content windows 172, 173, 174, 176, 182, and may be related in some manner to the content (e.g., related to the Talent, the topic being discussed, the location of the user and/or talent, and so on). The commercial content may be tailored to the user, such that the primary user may receive different commercial content from the secondary user and other secondary users may receive different commercial content from other secondary users. After operation 314, the method 300 may proceed to an end state 316 and terminate.

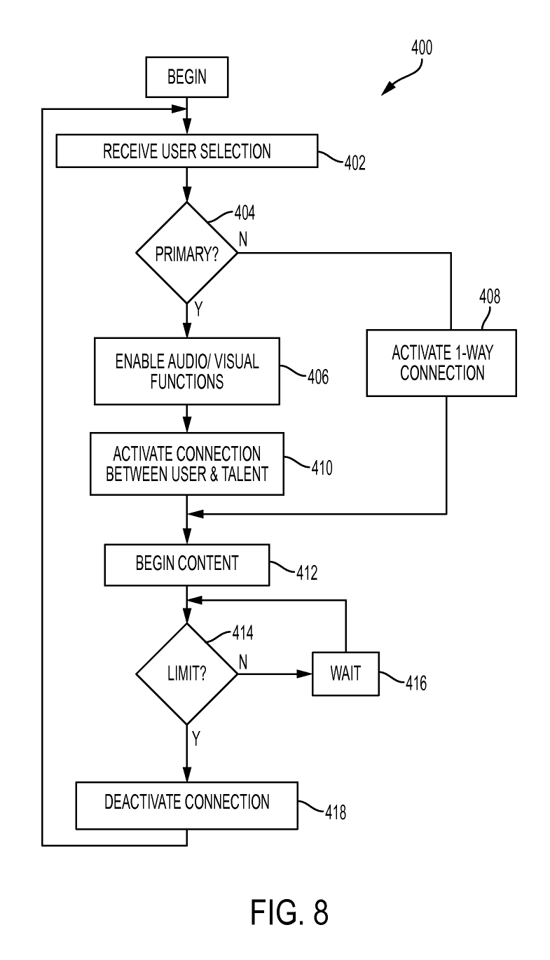

Another method for selectively providing tiered content to users will now be discussed. FIG. 8 is a flow chart illustrating another method for providing content to primary and secondary users. With reference to FIG. 8, the method 400 may begin with operation 402. In operation 402, the host device 106 may receive a user selection of a particular content slot. For example, using the purchasing GUI 150, the user may input a selection of a content slot via his or her user device 102 and the selection is transmitted via the network 108 to the host device 106.

After the user selection is received, the method 400 may proceed to operation 404. In operation 404, the host device 106 determines whether the user selection is for a primary pathway, e.g., a primary content selection. If the user selection is not primary, the method 400 may proceed to operation 408 and a secondary communication pathway may be activated. For example, a one-way or passive connection between the user device and the Talent may be activated. However, if in operation 404, the user selection is primary, the method 400 may proceed to operation 406.

In operation 406 the host device 106 enables one or more audio/visual functions for the primary user device. In other words, the host device 106 transmits the primary GUI 170 to the user device, which allows the user device to provide at least one type of input to vary the content. After operation 406, the method 400 may proceed to operation 410. In operation 410, the host device 106 may activate a primary connection between the primary user and the Talent. The primary connection may be a direct connection to the primary user device and the Talent device, or may be hosted by the host device 106 as an intermediary. The primary connection allows the primary user and the Talent to create content (e.g., a videoconference) as they interact with each other. For example, the user may ask the Talent one or more questions, may discuss events, may share photographs, videos, or other media, and so on, via the primary connection.

After operation 410, the content may begin and the Talent and the user may interact with each other. As the content begins in operation 410, the primary user may interact with the Talent while the secondary user may observe, listen, or otherwise passively engage with the content, such as watching a videoconference between the primary user and the talent. However, the secondary user may interact with the content in real time or otherwise while the primary connection is active so that the secondary user may participate (albeit passively) while the content is being created.

After operation 412, the method 400 may proceed to operation 414. In operation 414, the processing element 110 of the host device 106 determines whether the time limit for the content has been reached. As discussed above, many of the content slots may be based on time, where the primary and/or secondary users purchase a content slot for a predetermined time amount, e.g., half an hour, one hour, etc. If the time limit has not been reached, the method 400 may proceed to operation 416. In operation 416, the host device 106 may wait for a predetermined period of time before returning to operation 414. In this example, the time remaining in the content may be displayed as part of the status icons 186 on the primary user GUI 170 and/or the secondary user GUI 180, which may also include a function to allow a user to purchase additional time before the predetermined time has been reached.

If in operation 414, the time limit has been reached, the method 400 may proceed to operation 418. In operation 418, the primary and secondary communication pathways may be deactivated or terminated and the method may return to operation 402.

The foregoing description has broad application. For example, while examples disclosed herein may focus on live content, it should be appreciated that the concepts disclosed herein may equally apply to other types of content, such as prerecorded or previously created content. Similarly, although the methods may be discussed with respect to computing devices, such as smart phones and tablet computers, the devices and techniques disclosed herein are equally applicable to other content devices such as set top boxes. Accordingly, the discussion of any embodiment is meant only to be exemplary and is not intended to suggest that the scope of the disclosure, including the claims, is limited to these examples.

What is claimed is:

1. A method for providing live content comprising:
providing by a processing element a primary content slot and a secondary content slot for purchase;
receiving by the processing element a user selection of the primary content slot;
receiving by the processing element a user selection of the secondary content slot;
enabling by the processing element a primary communication pathway to a primary user device and a host device for the live content; and
enabling by the processing element a secondary communication pathway to a secondary user device for the content for transmitting the content live with respect to the primary communication pathway, wherein the secondary communication pathway is more restricted than the primary communication pathway.

2. The method of claim 1, wherein the content in enabled in real time for both the primary communication pathway and the secondary communicating pathway.

3. The method of claim 1, wherein
the primary communication pathway is two-way; and
the secondary communication pathway is one-way.

4. The method of claim 1, wherein the user selection of the primary content slot comprises receiving by the processing element a purchase of the primary content slot.

5. The method of claim 4, wherein the user selection of the secondary content slot comprises receiving by the processing element a purchase of the secondary content slot.

6. The method of claim 1, wherein the primary communication pathway leads to a talent device.

7. The method of claim 6, wherein the primary communication pathway allows the primary user device to transmit input to the talent device.

8. The method of claim 1, wherein the primary communication pathway transmits and receives data to and from the primary user device.

9. The method of claim 1, wherein the secondary communication pathway transmits data to the secondary user device.

10. The method of claim 1, further comprising transmitting content via the primary communication pathway and the secondary communication pathway to the primary and secondary user devices, respectively, wherein the content comprises an interactive videoconference between a primary user and a celebrity.

11. The method 10 further comprising transmitting a first advertisement to the secondary user device, wherein second advertisement is related to the content.

12. The method of claim 10 further comprising:
determining by the processing element if a time limit corresponding to the primary user selection has been reached; and
when the time limit has been reached, transmitting by the processing element a time limit notification to the primary user device.

13. The method of claim 12, further comprising prior to the reaching the time limit transmitting a purchase additional time notification to the primary user device.

14. A method for distributing content comprising:
transmitting by a processing element to a user device a menu of content selections, wherein the content selections correspond to a schedule of a talent;
receiving by the processing element a user selection corresponding to one or more content sections;
determining a ranking of the user selection based on a predetermined metric; and
when the user selection has a high ranking, activating a primary connection to the user device corresponding to the content selection, wherein the primary connection provides live content to the user device from a talent device corresponding to the talent; and
when the user selection has a low rank, transmitting a rank notification to the user device.

15. The method of claim 14, wherein the primary connection provides a two-way interaction with the user device.

16. A system for providing substantially live content comprising:
a host computing device including a processing element configured to perform the following operations:
providing by a processing element a primary content slot and a secondary content slot for purchase;
receiving by the processing element a user selection of the primary content slot;
receiving by the processing element a user selection of the secondary content slot;
enabling by the processing element a primary communication pathway to a primary user device and a host device for the content; and
enabling by the processing element a secondary communication pathway to a secondary user device for the content, wherein the secondary communication pathway is more restricted than the primary communication pathway; and
a user computer device configured to perform the following operations:
transmit the user selection of at least one of the primary content slot or secondary content slot;
display by a display device the content, wherein one or more functions of the user device to interact with the content are determined by whether the communication pathway is the primary communication pathway or the secondary communication pathway.

17. A method for providing live content comprising:
providing by a processing element an upper tier content slot, a lower tier primary content slot, and a plurality of secondary content slots for purchase;
receiving by the processing element a user selection of the upper tier primary content slot;
receiving by the processing element a user selection of the lower tier primary content slot;
receiving by the processing element a user selection of the secondary content slot;
enabling by the processing element an upper tier primary communication pathway to an upper tier primary user device and a host device for the live content;
enabling by the processing element a lower tier primary communication pathway to a lower tier primary user device and the host device for the live content; and
enabling by the processing element a secondary communication pathway to a secondary user device for the content for transmitting the live content with respect to the upper tier primary communication pathway, wherein the secondary communication pathway is more restricted than the upper tier primary communication pathway.

18. The method of claim 17, wherein the upper tier primary user device can selectively disable one or more transmissions along the lower tier primary communication pathway from the lower tier primary user device to the host device.

19. The method of claim 17, wherein the upper tier primary communication pathway is open for a longer period of time than the lower tier primary communication pathway.
